(19) United States
(12) Patent Application Publication
(10) Pub. No.: US 2004/0129726 A1
(43) Pub. Date: Jul. 8, 2004

(54) Dual chambered dedicated underground storage tank

(76) Inventor: Ray J. Hutchinson, Houma, LA (US)

Correspondence Address: WITHROW & TERRANOVA, P.L.L.C., P.O. BOX 1287, CARY, NC, 27512, US

(21) Appl. No.: 10/337,221

(22) Filed: Jan. 6, 2003

(51) Int. Cl. B67D 5/52

(52) U.S. Cl. 222/135; 222/131; 222/385

(57) ABSTRACT

A fueling environment reduces the likelihood of fuel spilling into the environment by positioning an underground storage tank directly beneath one or more fuel dispensers. The amount of piping thereby exposed to the environment is reduced, reducing the locations at which a leak may occur. The underground storage tank is partitioned into two or more chambers to hold different fuel grades such that a single tank may provide at least two fuel grades to the dispensers above the tank.

### FIELD OF THE INVENTION

The present invention is related to underground storage tanks in a service station fueling environment having a plurality of chambers to hold a plurality of different fuel types.

### BACKGROUND OF THE INVENTION

Fueling environments, such as service stations, must have a fuel supply from which fuel may be extracted and delivered to a fuel dispenser for delivery to consumers. The most conventional fuel supply is an underground reservoir, typically referred to as an underground storage tank. Service stations typically have at least two underground storage tanks, and sometimes three or four underground storage tanks to hold different types of fuel. For example, a first underground storage tank may contain low octane fuel; a second underground storage tank may contain high octane fuel; a third underground storage tank may contain an intermediate grade of fuel; and a fourth underground storage tank may contain diesel fuel. Pipes carry the fuel from the underground tanks to the fuel dispensers. Further, pipes may carry vapors removed during refueling of a vehicle from the fuel dispensers back to the underground storage tanks called “stage 2” vapor recovery.

Environmental regulations have been passed at the state and federal level which require monitoring of fuel leaking into the environment from components in a fueling environment. To help catch leaks before they grow to environmentally threatening events, fueling environments have installed leak detection sensors and perform leak inspections periodically. Further, the land containing the fuel elements may be treated to help contain any leaks. For example, a concrete trench may contain piping components and a concrete bed with fill material may be used to house underground storage tanks.

Because many fueling environments have multiple fuel dispensers and only one set of underground storage tanks, at least some of the fuel dispensers, of necessity, are positioned remotely from the underground storage tanks. This causes the piping interconnecting the underground storage tanks with the fuel dispensers to be extensive and frequently spread out over a relatively large lateral area below ground level. The extensive piping network requires more leak detection sensors and increases the amount of land which must be treated to help contain leaks.

The problems experienced by fueling environments are exacerbated in high volume retail (HVR) environments such as fueling environments associated with member only discount price club stores. Specifically, HVR environments associated with stores such as WAL-MART, K-MART, SAM's CLUB, COSTCO, and the like, may have many fuel dispensers compared to a typical fueling environment given their customers' high volume demands for fueling. These extra fuel dispensers each require the same piping connections, additional space, and create more opportunities for leaks.

Thus, it would be advantageous to provide a system for use in a fueling environment which minimized piping requirements, especially in HVR fueling environments.

### SUMMARY OF THE INVENTION

The present invention builds on the teachings of commonly invented U.S. patent application Ser. No. 10/209,962, filed Jul. 31, 2002, entitled CONTAMINANT CONTAINMENT SYSTEM IN A FUELING ENVIRONMENT, which is hereby incorporated by reference in its entirety.

A dedicated dual chambered underground storage tank may be positioned beneath a fueling island. The underground storage tank is dedicated in that it serves only those fueling islands directly above the tank, thus reducing the amount of fuel piping required. The dual chambers of the underground storage tank allow two grades of fuel to be supplied to the fueling islands, again reducing the need for piping from an underground storage tank remote from a fuel dispenser to deliver fuel to the fuel dispenser. Intermediate grades of fuel may be created by the fuel dispensers blending the high and low octane fuels from the dual chambered underground storage tank.

While the dual chambered dedicated underground storage tanks may result in more tanks being installed at a service station, the footprint of land that must be treated to contain leaks is smaller and the amount of piping that runs beneath the surface is minimized since each tank supplies all the fuel connections to the fuel dispensers directly above the tank.

As an alternate embodiment, the underground storage tank may have three or more chambers to accommodate differing types of fuel. In an exemplary embodiment, a third chamber is provided for intermediate octane fuel or diesel fuel. The size of the tank may change to reflect this additional chamber, or the tank may remain constant and the chambers reduced as needed or desired.

The underground storage tank may be a double-walled tank, and may include appropriate leak sensors that communicate with a tank monitor as needed or desired.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates an exemplary fueling environment and some of the communicative links therein;

FIG. 2 illustrates a cross-sectional view of a portion of a fueling environment showing one possible placement for the underground storage tank of the present invention;

FIG. 3 illustrates a cross-sectional view of a portion of a fueling environment showing an alternate placement for the underground storage tank of the present invention;

FIG. 4 illustrates an alternate embodiment of the embodiment illustrated in FIG. 2;

FIG. 5 illustrates a three chambered underground storage tank embodiment of the present invention;

FIG. 6 illustrates a first embodiment of a piping-underground storage tank interface;

FIG. 7 illustrates a second embodiment of a piping-underground storage tank interface;

FIG. 8 illustrates a flow chart outlining an exemplary method of constructing an underground storage tank according to the present invention; and

FIG. 9 illustrates a flow chart outlining an exemplary method of installing an underground storage tank according to the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

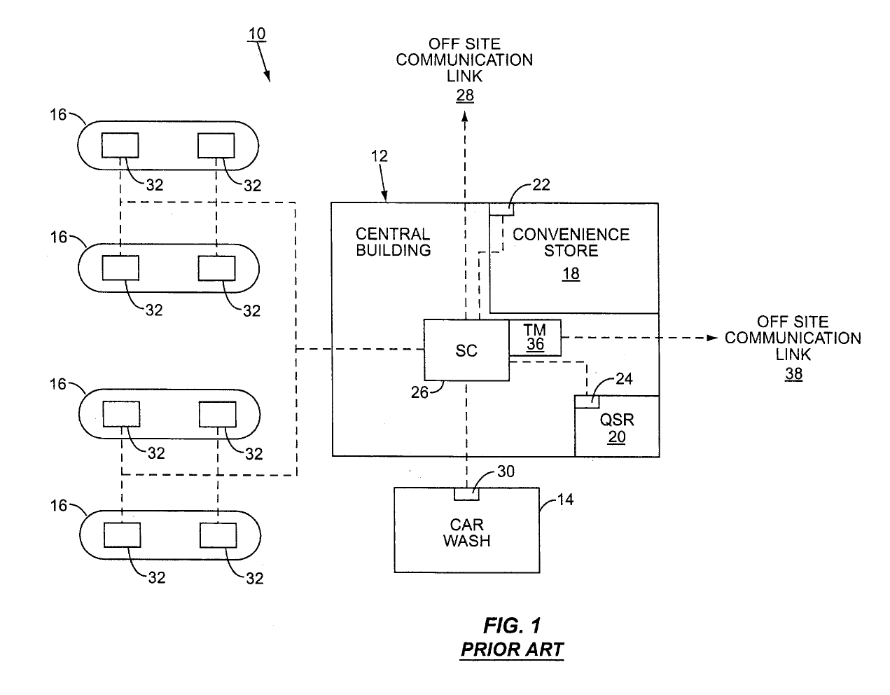

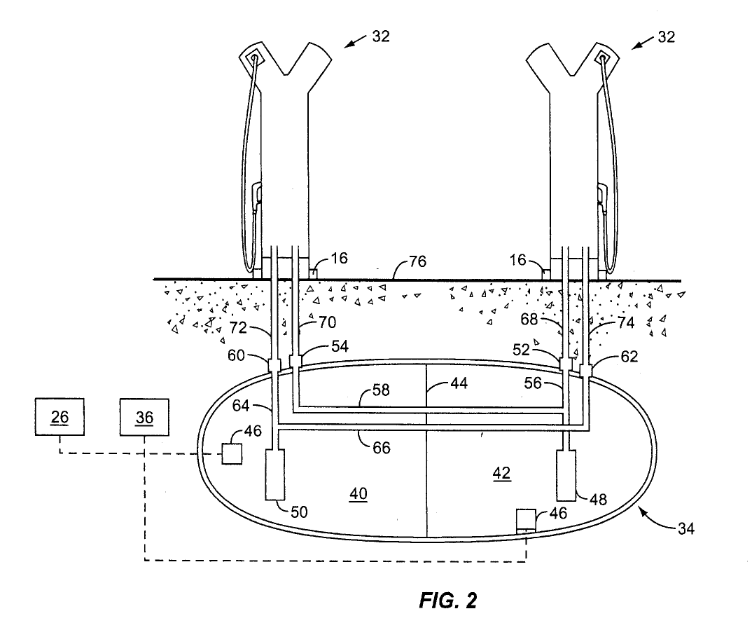

Fueling environments come in many different designs. Before describing the particular aspects of the present invention (which begins at the description of FIG. 2 below), a brief description of a fueling environment follows. A conventional, exemplary fueling environment 10 is illustrated in FIG. 1. Such a fueling environment 10 may comprise a central building 12, a car wash 14, and a plurality of fueling islands 16.

The central building 12 need not be centrally located within the fueling environment 10, but rather is the focus of the fueling environment 10, and may house a convenience store 18 and/or a quick serve restaurant 20 therein. Both the convenience store 18 and the quick serve restaurant 20 may include a point of sale 22, 24, respectively. The central building 12 may further house a site controller (SC) 26, which in an exemplary embodiment may be the G-SITE® sold by Gilbarco Inc. of Greensboro, N.C. The site controller 26 may control the authorization of fueling transactions and other conventional activities as is well understood. The site controller 26 may be incorporated into a point of sale, such as point of sale 22, if needed or desired. Further, the site controller 26 may have an off site communication link 28 allowing communication with a remote location for credit/debit card authorization, content provision, reporting purposes, or the like, as needed or desired. The off site communication link 28 may be routed through the Public Switched Telephone Network (PSTN), the Internet, both, or the like, as needed or desired.

The car wash 14 may have a point of sale 30 associated therewith that communicates with the site controller 26 for inventory and/or sales. purposes. The car wash 14 alternatively may be a stand alone unit. Note that the car wash 14, the convenience store 18, and the quick serve restaurant 20 are all optional and need not be present in a given fueling environment 10.

The fueling islands 16 may have one or more fuel dispensers 32 positioned thereon. The fuel dispensers 32 may be, for example, the ECLIPSE® or ENCORE® sold by Gilbarco Inc. of Greensboro, N.C. The fuel dispensers 32 are in electronic communication with the site controller 26 through a LAN or the like.

A tank monitor 36 may also be housed in the central building 12. The tank monitor 36 typically has fluid level sensors and other data gathering devices positioned in the underground storage tanks of the fueling environment 10, and potentially throughout the piping of the fueling environment 10, which are communicatively coupled to the tank monitor 36. The tank monitors 36 may communicate with the fuel dispensers 32 (either through the site controller 26 or directly, as needed or desired) to determine amounts of fuel dispensed and compare fuel dispensed to current levels of fuel within the underground storage tanks as reported by the sensors to determine if the underground storage tanks are leaking.

The tank monitor 36 may communicate with the site controller 26 and further may have an off site communication link 38 for leak detection reporting, inventory reporting, or the like. Much like the off site communication link 28, the off site communication link 38 may be through the PSTN, the Internet, both, or the like. If the off site communication link 28 is present, the off site communication link 38 need not be present and vice versa, although both links may be present if needed or desired. As used herein, the tank monitor 36 and the site controller 26 are site communicators to the extent that they allow off site communication and report site data to a remote location.

The present invention is also suitable for use with a high volume retailer (HVR). Such a HVR may be functionally identical to the fueling environment 10, but may reposition elements as needed. For example, the central building 12 may be a warehouse-like building, and the convenience store 18 may be turned into a full-fledged members-only discount store such as SAM's CLUB, COSTCO, or the like.

For further information on how elements of a fueling environment 10 may interact, reference is made to U.S. Pat. No. 5,956,259, which is hereby incorporated by reference in its entirety. Information about fuel dispensers may be found in commonly owned U.S. Pat. Nos. 5,734,851 and 6,052,629, which are hereby incorporated by reference in their entireties. Information about car washes may be found in commonly owned U.S. patent application Ser. No. 60/380,111, filed May 6, 2002, entitled IMPROVED SERVICE STATION CAR WASH, which is hereby incorporated by reference in its entirety. An exemplary tank monitor 36 is the TLS-350R manufactured and sold by Veeder-Root. For more information about tank monitors and their operation, reference is made to U.S. Pat. Nos. 5,423,457; 5,400,253; 5,319,545; and 4,977,528, which are hereby incorporated by reference in their entireties.

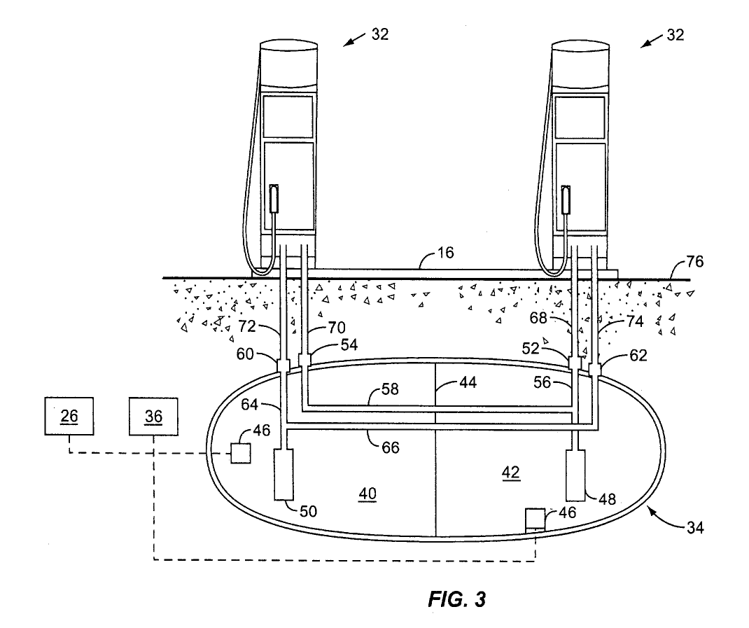

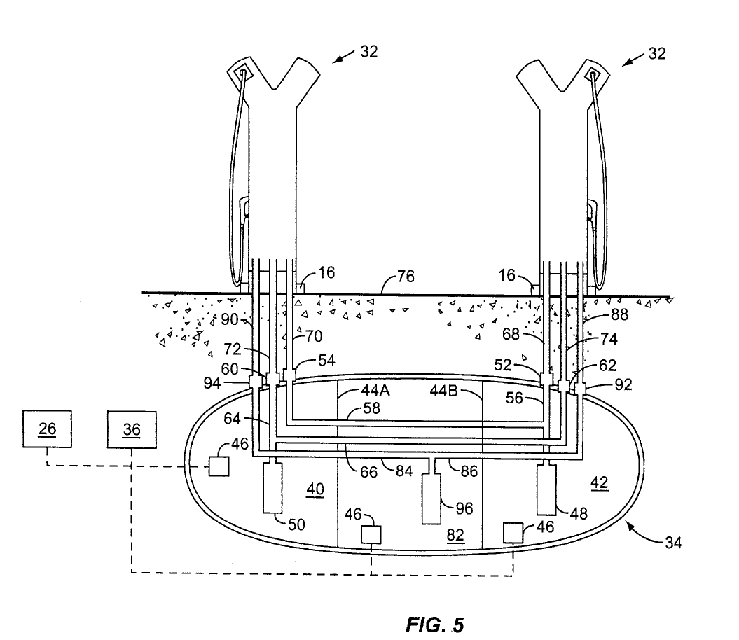

Against the backdrop of the fueling environment 10, the present invention comprises creating a underground storage tank 34 as illustrated in FIGS. 2 and 3. The underground storage tank 34 may be double-walled so that leaks occurring by a breach of the inner wall are contained. The underground storage tank 34 is divided into two or more chambers 40, 42 that house different grades of fuel therein. For example, first chamber 40 may house low octane (87 for example) fuel, and second chamber 42 may house high octane (93 for example) fuel. An intermediate grade of fuel may be achieved by blending in the fuel dispenser 32 or by pre-providing the intermediate grade and storing it in a third chamber (see FIG. 5). For more information on blending, the interested reader is directed to U.S. Pat. Nos. 4,876,653 and 5,029,100, both of which are hereby incorporated by reference in their entireties. Other fuel types such as diesel fuel may also be stored in one of the chambers 40, 42 if needed or desired. The wall 44 separating the chambers 40, 42 may be a double wall if needed or desired to insure fuel separation integrity. Note further that while the wall 44 is displayed as being a vertical wall, it is possible that the wall 44 could be horizontal or otherwise oriented as needed or desired.

Sensors 46 may be positioned in each chamber 40, 42 to determine fuel levels within the chambers 40, 42, detect contaminants, monitor vapor pressure, and the like as needed or desired. The sensors 46 may communicate with the site controller 26 or the tank monitor 36 (or both) as needed or desired. For a more detailed discussion of sensors 46, the interested reader is directed to U.S. Pat. Nos. 4,977,528; 5,544,518; 5,665,895, all of which are incorporated herein by reference in their entireties, and which describe tank-strapping curve sensors and the like.

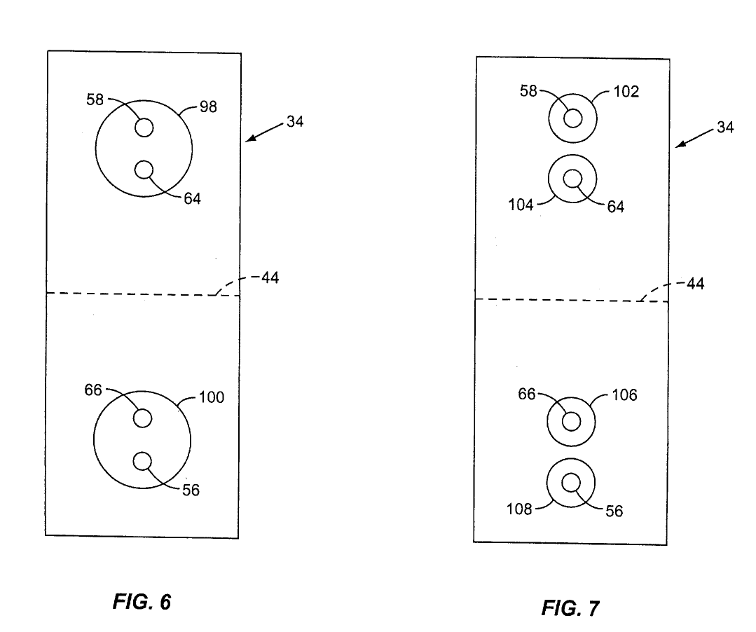

In addition to the sensors 46, submersible turbine pumps 48, 50 may be positioned within the chambers 40, 42 respectively. The submersible turbine pump 48 may fluidly communicate with distribution heads 52, 54 via pipes 56, 58 respectively. The pipes 56, 58 lead to two exit locations in the double-walled vessel that forms the underground storage tank 34. The submersible turbine pump 50 may fluidly communicate with distribution heads 60, 62 via pipes 64, 66 respectively. The pipes 64, 66 lead to two additional exit locations in the double-walled vessel that forms the underground storage tank 34. More detail on exit locations is presented below with respect to FIGS. 6 and 7 discussed later in this application. The pipes 56, 58, 64, and 66 may be double-walled pipes and are generally fully contained within the underground storage tank 34.

The submersible turbine pumps 48, 50 may be those sold under the trade name RED JACKET by Marley Pumps or the like as needed or desired such as that described in U.S. Pat. No. 6,126,409, incorporated herein by reference in its entirety. While it is possible that the motors and/or pumps of the submersible turbine pumps 48, 50 be positioned in the distribution heads and only a boom extended into the chambers 40, 42, such is not preferred.

Riser pipes 68, 70, 72, and 74 carry fuel from the distribution heads 52, 54, 60, and 62 to the fuel dispenser 32. In an exemplary embodiment, the riser pipes 68, 70, 72, and 74 are as short as feasible, meaning that the underground storage tank 34 is just beneath the level 76 of the pavement. This helps reduce the amount of piping that is exposed to the environment and thus able to leak into the environment. While not shown, vapor recovery piping may also be present and direct recovered vapor to one of the chambers 40, 42.

Note that in the embodiment of FIG. 2, the underground storage tank 34 crosses two fueling islands 16. In contrast, the embodiment of FIG. 3 serves two fuel dispensers 32 on the same fueling island 16. Note that in FIG. 3, the viewer sees the front faces of the fuel dispensers 32 as is well understood.

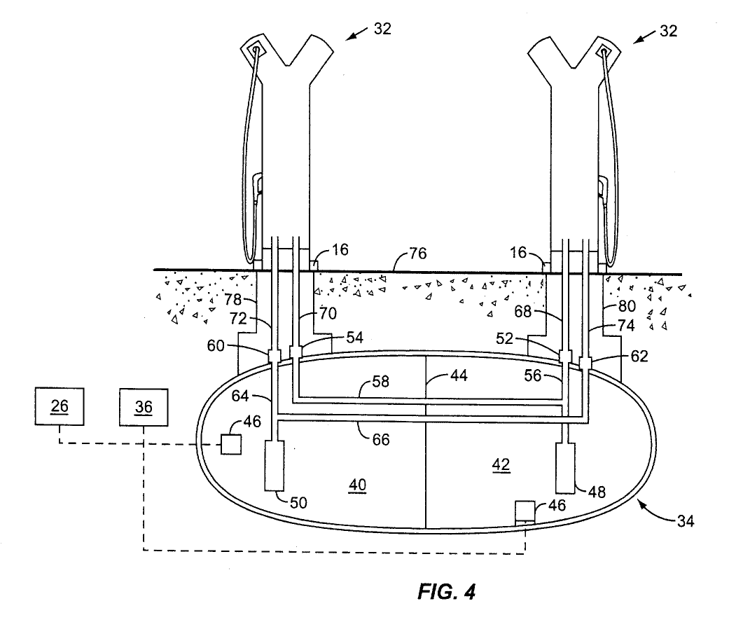

In FIG. 4, a permutation suitable for use with any of the embodiments is disclosed, and is shown for simplicity with the embodiment of FIG. 2. The sumps 78 and 80 are positioned around the risers 68, 70, 72, and 74 as illustrated. These sumps 78, 80 may be comparable to the ones sold by ENVIRON Products Inc. of P.O. Box 330, Smithfield, N.C., 27577, USA, and as illustrated in the concurrently submitted product catalog, which is hereby incorporated by reference. These sumps 78, 80 allow other containment options for the riser pipes 68, 70, 72, and 74 beyond a simple concrete or fill material containment scheme.

While it is contemplated that the underground storage tanks 34 will be dedicated to serve only those fuel dispensers 32 that are directly above the underground storage tanks 34, it is possible that the underground storage tanks 34 may serve more dispensers 32. U.S. Pat. Nos. 5,244,307; 5,921,712; and 6,270,285 all describe such alternate arrangements and are hereby incorporated by reference in their entireties. As used herein, the terms “above” and “beneath” mean at least partially directly above and beneath as opposed to an absolute vertical measurement.

FIG. 5 illustrates another alternate embodiment, in which the underground storage tank 34 has three chambers 40, 42, and 82 designed to hold three different fuel types. This configuration may be desirable if the fuel dispenser 32 requires three different types of fuel. For example, one chamber 82 may contain diesel fuel, and the other two chambers 40, 42 may contain high and low octane gasoline. Alternatively, the three chambers 40, 42, 82 may contain three different grades of gasoline. It should be appreciated that a four or more chambered underground storage tank 24 is also within the scope of the present invention. Additional pipes 84, 86 and riser pipes 88, 90 may be used along with distribution heads 92, 94. An additional sensor 46 and an additional submersible turbine pump 96 may also be used to complete the system. Walls 44A and 44B may fluidly isolate one chamber from the others. For the reasons explained above with respect to wall 44, walls 44A and 44B may be double walled.

FIGS. 6 and 7 illustrate two different embodiments for how the pipes exit the underground storage tank 34. In FIG. 6, a first aperture 98 may be designed such that pipes 58 and 64 may exit therefrom. A second aperture 100 may be designed such that pipes 56, 66 may exit therefrom. In practice, a collar or other capping mechanism (not illustrated) may be installed over the apertures 98, 100 and the distribution heads 52, 54, 60, and 64 mounted thereon. It should be appreciated that more pipes may extend through the apertures if there are more than two chambers 40, 42. For example, three pipes 58, 64, and 84 may extend through the first aperture 98 if a three chambered underground storage tank 34 is used.

In contrast, FIG. 7 illustrates dedicated apertures 102, 104, 106, and 108 for the pipes 56, 58, 64, and 66. In this embodiment, a collar or capping element is applied to each aperture 102, 104, 106, and 108 and a distribution head mounted thereon as needed or desired. Again, where an underground storage tank 34 has more than two chambers 40, 42, additional apertures may be used.

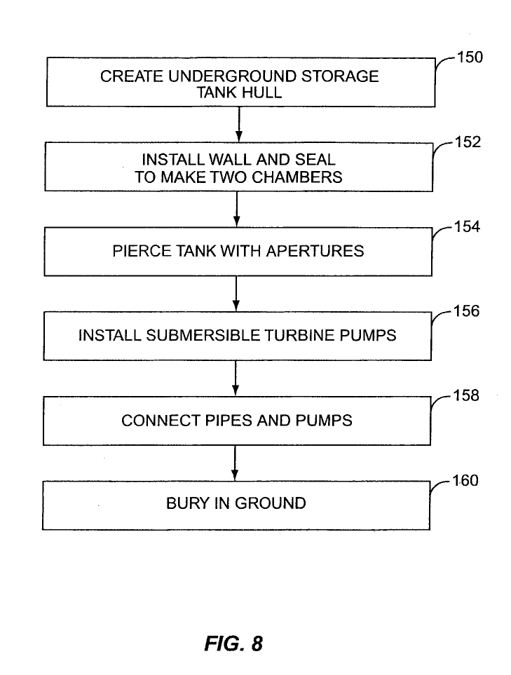

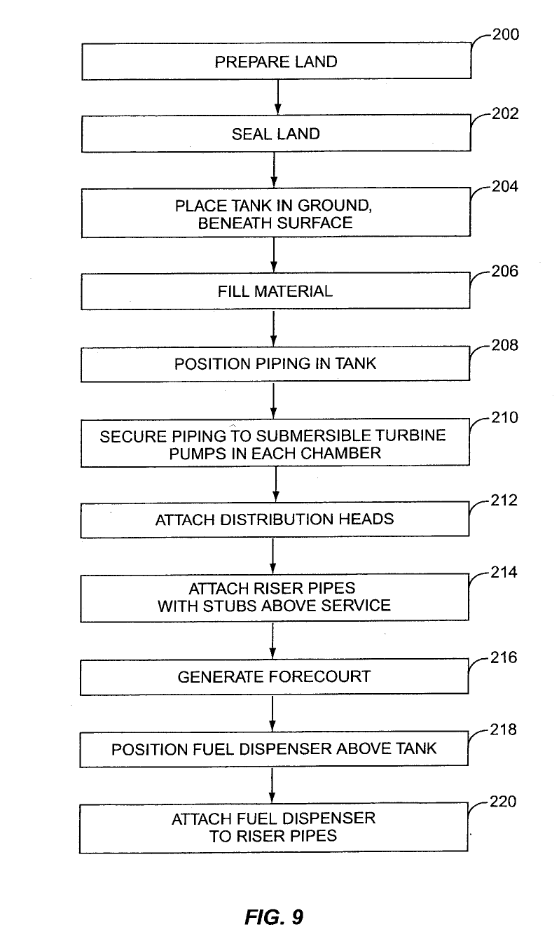

FIG. 8 illustrates an exemplary method of constructing an underground storage tank 34 according to the present invention. The interior hull of the double walled underground storage tank 34 is created (block 160). This step may include folding a piece of sheet metal or otherwise forming the interior wall. Once the hull is formed, or perhaps concurrently therewith, at least one interior wall 44 is installed to make at least two chambers 40, 42 within the underground storage tank 34 (block 152). The underground storage tank 34 is pierced with apertures 98, 100 or 102, 104, 106, and 108 to create exit apertures for the piping (block 154). Piercing as used herein includes cutting a hole in the walls of the underground storage tank 34, leaving voids in the walls which will form apertures, or other similar techniques to create apertures in the walls of the underground storage tank 34. The piping is positioned in the underground storage tank 34. The submersible turbine pumps 48, 50 are installed (block 156). A fitting collar or other device may be associated with the apertures and the distribution heads 52, 54, 60, and 62 secured to the underground storage tank 34. Exemplary fitting collars are sold by ENVIRON and are illustrated in the concurrently submitted catalog. The pipes and the submersible turbine pumps 48, 50 are connected (block 158). The seals and seams of the underground storage tank 34 are verified for integrity and then the underground storage tank 34 may be buried in the ground (block 160).

It should be appreciated that manufacturing concerns and limitations may necessitate the rearrangement of the order of the steps of FIG. 8. Specifically, it is possible that the pipes and the interior wall 44 may be created and connected to the submersible turbine pumps 48, 50 and the walls of the underground storage tank 34 built therearound. Alternatively, a cylinder may be created for the underground storage tank 34, all of the interior work done, and then end caps associated with the cylinder may be created to complete the underground storage tank 34. Other fabrication techniques may also be used. Note further that the underground storage tank 34 may be constructed to differing degrees of completion. Thus, in some fabricating techniques, the fitting collars and riser pipes may not be attached during fabrication. In still other embodiments, the submersible turbine pumps 48, 50 may not be preprovided inside the underground storage tank 34. Thus, those of ordinary skill in the art can appreciate that various levels of completion are possible and may provide pricing variations for consumers or other advantages.

FIG. 9 illustrates an exemplary embodiment of a method of installing an underground storage tank 34 according to the present invention. Initially, the land is prepared (block 200). This preparation usually entails excavating a section of earth to generate a cavity within the ground. This cavity is sealed (block 202). Sealing may be done with a concrete barrier, a liquid barrier, or the like as needed or desired. The underground storage tank 34 is then placed in the ground, and namely in the cavity, beneath the intended surface of the forecourt of the fueling environment 10 (block 204).

Fill material such as gravel, dirt, sand, or the like may be placed in the cavity (block 206). Before covering the top of the underground storage tank 34, the piping may be positioned in the underground storage tank 34 (block 208) and secured to the submersible turbine pumps 48, 50 in each chamber 40, 42 of the underground storage tank 34 (block 210).

The distribution heads 52, 54, 60, 62 are attached via fitting collars or other technique to the underground storage tank 34 (block 212). The riser pipes 68, 70, 72, 74 are attached to the distribution heads 52, 54, 60, 62, with the terminal ends thereof extending above the intended surface of the forecourt of the fueling environment 10 (block 214). Any sumps 78, 80 that are required may be associated with the underground storage tank 34 as needed or desired.

In many instances, a plurality of underground storage tanks 34 will be positioned in the fueling environment 10. Once every underground storage tank 34 is fully in place with all the proper leak detection equipment, fluid level sensors, communication links and the like, the forecourt may be created (block 216). This may entail pouring a concrete slab while leaving man hole apertures for access to sumps and the like as is well understood.

The fuel dispensers 32 are positioned above the underground storage tanks 34 (block 218) and the fuel dispensers 32 are attached to the riser pipes 68, 70, 72, 74 as is well understood (block 220).

Note that in some instances, it is possible that the piping, submersible turbine pumps 48, 50, collar fitting, distribution heads 52, 54, 60, 62 and riser pipes 68, 70, 72, 74 may be prefabricated and incorporated into the underground storage tank 34. In such an instance, the underground storage tank 34 is placed in the cavity, the fill material used, the sumps positioned, the forecourt created over the tank, and the fuel dispensers 32 attached to the riser pipes 68, 70, 72, 74. Variations in the level of completeness of the underground storage tank 34 are contemplated and within the scope of those of ordinary skill in the art to understand how to complete the installation. Likewise, those of ordinary skill in the art may note other ways of installing the components to achieve the present invention.

Those skilled in the art will recognize improvements and modifications to the preferred embodiments of the present invention. All such improvements and modifications are considered within the scope of the concepts disclosed herein and the claims that follow.

What is claimed is:

1. An underground storage tank, comprising:
a double-walled vessel;
a first chamber adapted to hold fuel positioned within the double-walled vessel;
a second chamber adapted to hold fuel positioned within the double-walled chamber; and
a wall positioned within said double-walled vessel separating said first chamber from said second chamber.

2. The underground storage tank of claim 1, wherein said wall comprises a double wall.

3. The underground storage tank of claim 1, further comprising a first set of piping adapted to convey fuel in said first chamber to two exit locations on the double-walled vessel.

4. The underground storage tank of claim 3, further comprising a second set of piping adapted to convey fuel in said second chamber to two additional exit locations on the double-walled vessel.

5. The underground storage tank of claim 1, further comprising a first submersible turbine pump, at least a portion of said first submersible turbine pump positioned in said first chamber.

6. The underground storage tank of claim 5, further comprising a second submersible turbine pump, at least a portion of said second submersible turbine pump positioned in said second chamber.

7. The underground storage tank of claim 5, further comprising a pair of distribution heads fluidly associated with said first submersible turbine pump and each adapted to be connected to a respective riser pipe for conveying fuel to a respective fuel dispenser.

8. A fueling system, comprising:
at least one fuel dispenser; and
an underground storage tank positioned at least partially beneath said at least one fuel dispenser, said underground storage tank comprising:
a double-walled vessel;
a first chamber adapted to hold fuel and positioned within said double-walled vessel; and
a second chamber adapted to hold fuel and positioned within said double-walled vessel and fluidly isolated from said second chamber;
said underground storage tank providing two different grades of fuel to said at least one fuel dispenser from said first and second chambers.

9. The fueling system of claim 8, further comprising a second fuel dispenser positioned at least partially above said underground storage tank.

10. The fueling system of claim 8, further comprising a first submersible turbine pump associated with said first chamber and adapted to deliver fuel stored in said first chamber to said at least one fuel dispenser.

11. The fueling system of claim 10, further comprising a second submersible turbine pump associated with said second chamber and adapted to deliver fuel stored in said second chamber to said at least one fuel dispenser.

12. The fueling system of claim 11, further comprising a plurality of riser pipes adapted to carry fuel from said submersible turbine pumps to said at least one fuel dispenser.

13. The fueling system of claim 8, further comprising a sensor associated with said first chamber for detecting leaks within said first chamber.

14. The fueling system of claim 12, further comprising a sump, said sump positioned around at least one of said riser pipes for containing leaks from said riser pipe.

15. The fueling system of claim 8, further comprising at least one distribution head positioned on said underground storage tank and adapted to help direct fuel from said underground storage tank to said at least one fuel dispenser.

16. The fueling system of claim 8, further comprising a first set of piping adapted to be contained within said double-walled vessel and deliver fuel stored in said first chamber to at least two exit locations on said double-walled vessel.

17. An underground storage tank, comprising:
a double-walled vessel;
a plurality of chambers each adapted to hold fuel and positioned within the double-walled vessel; and
at least one wall positioned within said double-walled vessel for fluidly isolating one chamber from another.

18. The underground storage tank of claim 17, wherein said at least one wall comprises a double wall.

19. The underground storage tank of claim 17, further comprising a first set of piping adapted to convey fuel in a first one of said plurality of chambers to two exit apertures on the double-walled vessel.

20. The underground storage tank of claim 19, further comprising a second set of piping adapted to convey fuel in a second one of said plurality of chambers to two additional exit apertures on the double-walled vessel.

21. A method of constructing an underground storage tank, comprising:
installing a wall to separate portions of the underground storage tank into at least two chambers, each chamber adapted to hold fuel therein.

22. The method of claim 21, wherein installing a wall comprises installing a plurality of walls to divide the underground storage chamber into at least three chambers, each chamber adapted to hold fuel therein.

23. The method of claim 21, further comprising piercing the underground storage tank with at least two apertures designed to allow piping positioned within the underground storage tank to exit the underground storage tank.

24. The method of claim 21, further comprising positioning a submersible turbine pump within each of said chambers.

25. The method of claim 21, further comprising burying the underground storage tank in a fueling environment.

26. A method of installing an underground storage tank in a fueling environment, comprising:
positioning a dual chambered underground storage tank beneath a surface; and
positioning at least one fuel dispenser at least partially above said dual chambered underground storage tank.

27. The method of claim 27, further comprising positioning piping within each chamber of the dual chambered underground storage tank such that the piping may convey fuel in both chambers of the dual chambered underground storage tank to said at least one fuel dispenser.

28. The method of claim 27, further comprising attaching said at least one fuel dispenser to said dual chambered underground storage tank with one or more riser pipes.

29. The method of claim 27, further comprising positioning a submersible turbine pump within said dual chambered underground storage tank.

30. The method of claim 29, further comprising positioning a second submersible turbine pump within a second one of said dual chambers of the dual chambered underground storage tank.

31. The method of claim 27 further comprising associating at least one distribution head with said dual chambered underground storage tank.

32. The method of claim 27, further comprising installing multiple underground storage tanks in a fueling environment.
